(19) United States
(12) Patent Application Publication
(10) Pub. No.: US 2023/0205847 A1
(43) Pub. Date: Jun. 29, 2023

(54) METHODS AND SYSTEMS FOR AUTOMATICALLY IDENTIFY IN A DATASET INSUFFICIENT DATA FOR LEARNING, OR RECORDS WITH ANOMALOUS COMBINATIONS OF FEATURE VALUES

(71) Applicant: International Business Machines Corporation, Armonk, NY (US)

(72) Inventors: Samuel Solomon Ackerman, Haifa (IL); Orna Raz, Haifa (IL); Marcel Zalmanovici, Kiriat Motzkin (IL); Eitan Daniel Farchi, Pardes Hana (IL); Avi Ziv, Haifa (IL)

(21) Appl. No.: 17/561,951

(22) Filed: Dec. 26, 2021

(51) Int. Cl. G06K 9/62

(52) U.S. Cl. CPC G06K 9/6219; G06K 9/6261

(57) ABSTRACT

Systems and methods for automatically identifying in a dataset insufficient data for learning, or records with anomalous combinations of feature values, by partition of numeric and/or categorical data space into human-interpretable regions are disclosed. The method comprises: receiving a dataset of numeric and/or categorical features with a plurality of observations.

Calculating observation density for each observation according to a distance or anomaly based metric, and receiving a density measurement. Partitioning the dataset along the numeric and/or categorical features according to the density measurement of each observation by a perpendicular cut along the feature spaces, receiving a map of a plurality of hyper-rectangular shapes representing various levels of density including empty spaces. Displaying the received map, being human-interpretable regions on a Graphic user interface, GUI, wherein the plurality of hyper-rectangular shapes are selectable and present information about the selected hyper-rectangular shape level of density when selected by a user.

### TECHNICAL FIELD

The present disclosure, in some embodiments thereof, relates to data exploration and visualization, more specifically, but not exclusively, to methods and systems for automatically identify in a dataset insufficient data for learning, or records with anomalous combinations of feature values, by partition of data space into human-interpretable regions.

### BACKGROUND

The feature space of a dataset is the product of the ranges (if numeric) or sets of values (if categorical) of the dataset features. An example for three features is {STATE in {AL, . . . , WY}} & {AGE in {35, A<=INCOME<=$500,000}. Due to domain-specific or other factors, while this feature space circumscribes (contains within it) all dataset observations, the dataset observations may be unevenly spread within the potential feature space. For instance, there may be few people with high incomes while most people have low or moderate incomes. This means different areas of the potential space have differing observation density, and many areas may be empty. Being able to describe the feature space according to observation density is a basic task for data exploration and conceptualization. It can also be useful when the data is to be used for a learning task, as the density of a given area can differentially affect a machine learning (ML) model's accuracy when used for training or testing.

### SUMMARY

It is an object of the present disclosure to describe a system and a method for automatically identify in a dataset insufficient data for learning, or records with anomalous combinations of feature values, by partition of data space into human-interpretable regions.

The foregoing and other objects are achieved by the features of the independent claims. Further implementation forms are apparent from the dependent claims, the description and the figures.

In one aspect, the present disclosure relates to a computerized method for automatically identifying in a dataset insufficient data for learning, or records with anomalous combinations of feature values, by partition of numeric and/or categorical data space into human-interpretable regions, comprising:

receiving a dataset of numeric and/or categorical features with a plurality of observations;

calculating observation density for each observation according to a distance or anomaly based metric, and receiving a density measurement representing a density of each observation;

partitioning the dataset along the numeric and/or categorical features according to the density measurement of each observation by a perpendicular cut along the feature spaces, receiving a map of a plurality of hyper-rectangular shapes representing various levels of density including empty spaces;

displaying the received map of plurality of hyper-rectangular shapes, being human-interpretable regions on a Graphic user interface, GUI, wherein the plurality of hyper-rectangular shapes are selectable and present information about the selected hyper-rectangular shape level of density when selected by a user.

In a second aspect, the present disclosure relates to system for automatically identifying in a dataset insufficient data for learning, or records with anomalous combinations of feature values, by partition of numeric and/or categorical data space into human-interpretable regions, comprising:

a processor executing a code, adapted to:
receive a dataset of numeric and/or categorical features with a plurality of observations;
calculate observation density for each observation according to a distance or anomaly based metric, and receiving a density measurement representing a density of each observation;
partition the dataset along the numeric and/or categorical features according to the density measurement of each observation by a perpendicularly cut along the feature spaces, receiving a map with a plurality of hyper-rectangular shapes representing various levels of density including empty spaces; and

a graphic user interface, GUI, controlled by the processor, which displays the map with the plurality of hyper-rectangular shapes, being human-interpretable regions, wherein the plurality of hyper-rectangular shapes are selectable and present information about the selected hyper-rectangular level of density when selected by a user.

In a third aspect, the present disclosure relates to computer program product for automatically identifying in a dataset insufficient data for learning, or records with anomalous combinations of feature values, by partition of numeric and/or categorical data space into human-interpretable regions, the computer program product comprising:
one or more computer readable storage media, and program instructions collectively stored on the one or more computer readable storage media, the program instructions comprising:
program instructions to receive a dataset of numeric and/or categorical features with a plurality of observations;
program instructions to calculate observation density for each observation according to a distance or anomaly based metric, and receiving a density measurement representing a density of each observation;
program instructions to partition the dataset along the numeric and/or categorical features according to the density measurement of each observation by a perpendicular cut along the feature spaces, receiving a map of a plurality of hyper-rectangular shapes representing various levels of density including empty spaces; and
program instructions to display the received map of plurality of hyper-rectangular shapes, being human-interpretable regions on a Graphic user interface, GUI, wherein the plurality of hyper-rectangular shapes are selectable and present information about the selected hyper-rectangular shape level of density when selected by a user.

In a further implementation of the first second and third aspects, a machine learning is applied to the dataset which comprises:

insufficient data for a trained machine learning model to provide high accuracy results; or

records with anomalous combinations of feature values, which indicates on errors in the machine learning model results or errors in input data.

In a further implementation of the first aspect, the method further comprises:

calculating additional metrics of volume spanned by the hyper-rectangular shapes; deviation of fraction of observations contained in a hyper-rectangular shape from the fractional volume contained in the hyper-rectangular shape, to measure how uneven the observations are spread in a multi-dimensional space.

In a further implementation of the first aspect, partitioning is done so that the partitions differ as much as possible among themselves in density.

In a further implementation of the first aspect, observation density for each observation is done by clustering the dataset of numeric and/or categorical features using Ordering Points To Identify the Clustering Structure, OPTICS, with Gower's metric.

In a further implementation of the first aspect, calculating observation density for each observation is done by calculating an anomaly score to each observation, where a higher anomaly score corresponds to lower density.

In a further implementation of the first aspect the anomaly based metric is Isolation Forests, IF.

In a further implementation of the first aspect, partitioning the dataset along the numeric and/or categorical features is done by a regression decision tree.

In a further implementation of the first aspect, partitioning the dataset along the numeric and/or categorical features, is recursive.

In a further implementation of the first aspect the perpendicular cut is successive.

In a further implementation of the first aspect a given percentage p of highest values of a target yi to consider as indicating an outlier, and the observations xi with the highest p percent of targets yi are omitted before defining S and conducting the partition.

In a further implementation of the first aspect a given percentage p of lowest values of a target yᵢ to consider as indicating an outlier, and the observations xi with the lowest p percent of targets yᵢ are omitted before defining S and conducting the partition.

In a further implementation of the first aspect, an empty space is searched for in two locations:
only on a feature and split value used by the regression tree at a same step; and
after splitting, at any feature and location of outside of observed points in a same region.

In a further implementation of the first aspect, an internal empty space is found in a given region, which splits the region into at least one empty region and, at least two new non-empty regions.

In a further implementation of the first aspect, a machine learning is applied to the dataset which comprises:

insufficient data for a trained machine learning model to provide high accuracy results; or

records with anomalous combinations of feature values, which indicates on errors in the machine learning model results or errors in input data.

In a further implementation of the second aspect, the processor further adapted to:

calculate additional metrics of volume spanned by the hyper-rectangular shapes; deviation of fraction of observations contained in a hyper-rectangular shape from the fractional volume contained in the hyper-rectangular shape, to measure how uneven the observations are spread in a multi-dimensional space.

In a further implementation of the third aspect, a machine learning is applied to the dataset which comprises:

insufficient data for a trained machine learning model to provide high accuracy results; or

records with anomalous combinations of feature values, which indicates on errors in the machine learning model results or errors in input data.

In a further implementation of the third aspect, the computer program product further comprises:

program instructions to calculate additional metrics of volume spanned by the hyper-rectangular shapes; deviation of fraction of observations contained in a hyper-rectangular shape from the fractional volume contained in the hyper-rectangular shape, to measure how uneven the observations are spread in a multi-dimensional space.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 schematically shows a block diagram of a system for, according to some embodiments of the present disclosure;

FIG. 2 schematically shows a flowchart of a method for, according to some embodiments of the present disclosure;

FIG. 3 schematically shows an example, where a regression tree maps a univariate feature x=F1 to a numeric target y, where yi=f(xi) is the kernel density estimation (KDE) of F1 at a given value xi, according to some embodiments of the present disclosure;

FIG. 4 schematically shows an illustrative example of empty spaces around split between S7 and S8 in FIG. 3, according to some embodiments of the present disclosure; and

FIGS. 5a-5c schematically show an example of density-based partition of n=1000 observations from ‘Adult’ dataset on F₁=AGE and F₂=HOURS PER WEEK, where in FIG. 5a minL=0.0, in FIG. 5b minL=0.1, and in FIG. 5c minL=1.0, according to some embodiments of the present disclosure.

### DETAILED DESCRIPTION

The present disclosure, in some embodiments thereof, relates to data evaluation and presentation and, more specifically, but not exclusively, to methods and systems for automatically identify in a dataset insufficient data for learning, or records with anomalous combinations of feature values, by partition of data space into human-interpretable regions.

Data exploration and analysis algorithms usually relate to the data existing in the dataset. However, no relation is provided to insufficient data, lack of data or absence of data.

In addition, the task of conducting data exploration, visualization, and analysis, on a structured feature dataset is challenging. The difficulties often increase when the data is high-dimensional and has mixed feature types (numeric, nominal categorical, ordinal categorical). Furthermore, it is often difficult to provide analyses that are in a meaningful format for a human user to interpret and gain insights into the data.

There are methods for grouping dataset records by density. However, clustering methods do not group the data into subsets that are of a shape or nature that is human-interpretable. Particularly, these are hard to visualize when the data is more than a few dimensions, or contain a mix of numeric and categorical features.

There is therefore a need for a method and system, for identifying in a dataset insufficient data for learning or records with anomalous combinations of feature values, which provide human-interpretable results.

The present disclosure, in some embodiments thereof, describes a system and a method, which identify in a dataset of arbitrary feature dimension size, insufficient data for learning, or records with anomalous combinations of feature values, where the features may be of mixed type, by partitioning the feature space into regions according to the relative density of observed points. The regions are presented in a form that is intuitive for human interpretation. From these regions, a user can understand where in the potential space most of the data are. According to some embodiments of the present disclosure, the method also finds empty spaces of the same form, where data records are not observed to exist. These may be empty due to domain-specific feature constraints (i.e., a knowledgeable person would expect them to be empty), but they may still be of interest to the user.

in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer and/or computerized device, partly on the user's computer and/or computerized device, as a stand-alone software package, partly on the user's computer (and/or computerized device) and partly on a remote computer or entirely on the remote computer or server. In the latter scenario, the remote computer may be connected to the user's computer and/or computerized device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

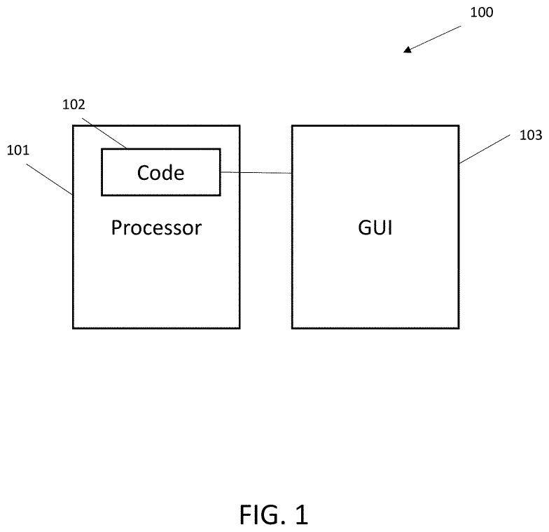

Reference is now made to FIG. 1, which schematically shows a block diagram of a system for automatically identifying in a dataset insufficient data for learning, or records with anomalous combinations of feature values, by partition of numeric and/or categorical data space into human-interpretable regions, according to some embodiments of the present disclosure. System 100, includes a processor 101, which executes a code 102 for identifying in a dataset insufficient data for learning, or records with anomalous combinations of feature values, by partition of numeric and/or categorical data space into human-interpretable regions. Processor 101, receives as an input a dataset of numeric and/or categorical features with a plurality of observations. Then the processor 101 executes code 102, which calculates observation density for each observation in the dataset received, according to a distance or anomaly based metric. The code 102 provides a density measurement representing a density of each observation. Code 102 partitions the dataset along the numeric and/or categorical features according to the density measurement of each observation by a perpendicularly cut along the feature spaces, receiving a map with a plurality of hyper-rectangular shapes representing various levels of density including empty spaces. Then processor 101, controls a graphic user interface, GUI, which includes a display and, which displays the map with the plurality of hyper-rectangular shapes, being human-interpretable regions. According to some embodiments of the present disclosure, the plurality of hyper-rectangular shapes presented on the display of the GUI are selectable and present information about the selected hyper-rectangular level of density when selected by a user. The different hyper-rectangular shapes may differ in color and shape to ease the difference between the different hyper-rectangular shapes.

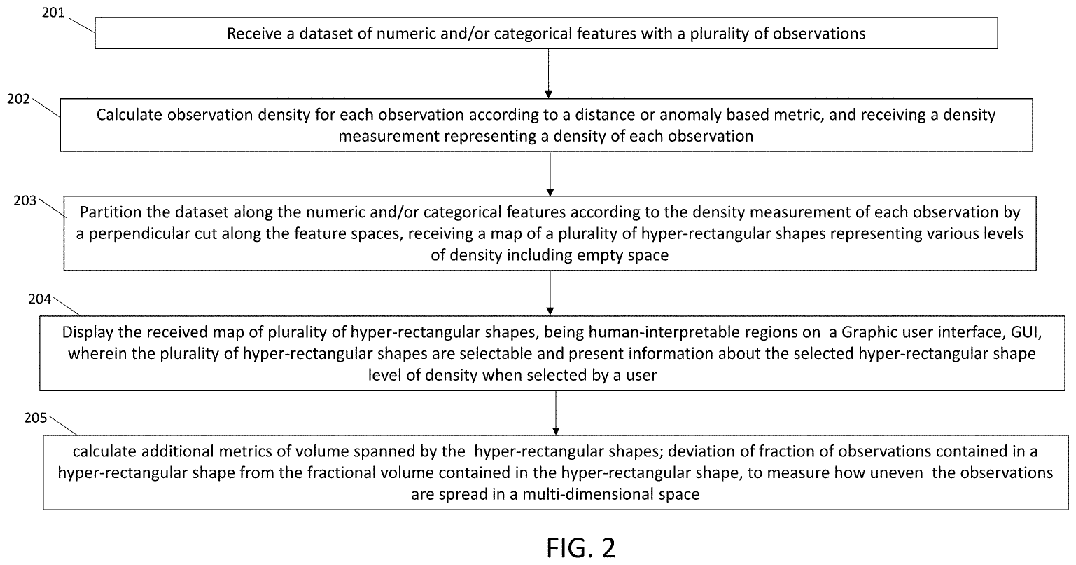

Reference is now made to FIG. 2, which schematically shows a flow chart of a computerized method for automatically identifying in a dataset insufficient data for learning, or records with anomalous combinations of feature values, by partition of numeric and/or categorical data space into human-interpretable regions, according to some embodiments of the present disclosure. At 201, a dataset of numeric and/or categorical features with a plurality of observations is received by processor 101, as an input for the execution of code 102. According to some embodiments of the present disclosure, a machine learning may be applied to the dataset and the dataset may be with insufficient data for a trained machine learning model to provide high accuracy results, or records with anomalous combinations of feature values, which indicates on errors in the machine learning model results or errors in input data.

At 202, code 102 is executed by processor 101, and observation density is calculated for each observation, according to a distance or anomaly based metric, and receiving a density measurement representing a density of each observation. According to some embodiments of the present disclosure, the calculation of each observation density is done by clustering the dataset of numeric and/or categorical features using for example Ordering Points To Identify the Clustering Structure (OPTICS) with Gower's metric. Another option for calculating the observation density may be by calculating an anomaly score to each observation, where a higher anomaly score corresponds to lower density. An example for an anomaly based metric that may be used is Isolation Forests, IF.

According to some embodiments of the present disclosure, at 203, the dataset is partitioned along the numeric and/or categorical features according to the density measurement of each observation by a perpendicular cut along the feature spaces, and a map of a plurality of hyper-rectangular shapes representing various levels of density including empty spaces is received. Optionally the partition along the numeric and/or categorical features may be recursive, and the perpendicular cut may be successive. The partition of the dataset along the numeric and/or categorical features may be done for example by a regression decision tree. The map with the plurality of hyper-rectangular shapes being human-interpretable regions is displayed at 204, on a display of a Graphic User Interface, GUI. The plurality of hyper-rectangular shapes are selectable and present information about the selected hyper-rectangular shape level of density when selected by a user. At 205, optionally, additional metrics of volume spanned by the hyper-rectangular shapes, and deviation of fraction of observations contained in a hyper-rectangular shape from the fractional volume contained in the hyper-rectangular shape is calculated, to measure how uneven the observations are spread in a multi-dimensional space.

According to some embodiments of the present disclosure, the partition is done so that the partitions differ as much as possible among themselves in density. That is, it is desirable, if possible, to have a set of partitions where some are dense, sparse, and empty, rather than a set of partitions that are more similar in terms of the density of observations in them. This is done without having to specify a grid or discretization on numeric features, and can handle different feature types together. According to some embodiments of the present disclosure, the resulting partitions are interpretable to humans and easily defined mathematically such that they may be easily mapped to another dataset. The criterion for “human-interpretable” is that partition definitions be defined as a conjunction of ranges (numeric) or sets of values (categorical), and create a hyper-rectangular shape, which is intuitive for human to understand. In addition, the results of the method of the present disclosure tells the user where the data are not, by providing empty spaces, which contain no data. The empty spaces are also informative for the user and provide information that is useful. For example, in a case of a trained machine learning model which received an input dataset with empty spaces, the user may infer that the dataset contains insufficient data for the trained machine learning model to provide high accuracy results. Alternatively, the user may infer that the dataset contains records with anomalous combinations of feature values, which indicates on errors in the machine learning model results or errors in input data. According to some embodiments of the present disclosure, the code 102 executed by processor 101, is able to handle numeric and categorical features together without needing a pre-gridding of the feature space, in contrast to other methods, which handle numeric features only, and require a pre-gridding of the feature space.

According to some embodiments of the present disclosure, an example for implementing the method described herein may be by applying iteratively the following steps: calculating a numeric target y={yᵢ}, n i=1 that serves as an approximation for the density of observation i. Then, using regression trees with target y to partition the feature space S, on features F₁, . . . , Fₚ, and carve out empty space along the way from the newest resulting split.

According to some embodiments of the present disclosure, a numeric target yᵢ is required for each observation xᵢ, which represents this observation's multivariate density within the feature space S. Alternatively, yᵢ may also be some score, which does not necessarily directly measure density but is associated with some attributes of density. Observations with high density should have many other points within a small neighborhood, while sparse points should have relatively few neighborhoods or be surrounded by more empty space, yᵢ then serves as the target for partition. As such, it should be approximately monotonically increasing or decreasing with the density of xᵢ, that is, a higher value can represent higher density or more anomalousness, which should correspond to lower density. There are several methods that may be used. One is to use a distance-based clustering algorithm, such as OPTICS (Ordering Points To Identify the Clustering Structure), where a numeric output such as the core distance of xᵢ may be used as yᵢ, the cluster identifications are not used. In OPTICS, the core distance is the distance from xᵢ to its m^{th} closest neighbor, where m is the (user-specified) minimum number of observations within an E-radius neighborhood of xᵢ for it to be considered a core point. Thus, a lower core distance should indicate a higher density of xᵢ. Gower distance is a metric, which calculates the multivariate distance between observations xᵢ and x₃ as the average of their feature-wise distances. The distances may be tailored to the feature type (e.g., range-normalized Manhattan distance for numeric, Dice coefficient for nominal categorical, or Manhattan distance for ordered categorical), which means it may apply to mixed data types. If Gower distance is used as the distance metric in, for example, OPTICS, the core distance (i.e., yᵢ) may be considered as a distance-based density measure of observation xᵢ. Depending on the implementation, clustering-based methods can also scale poorly with n in terms of computational complexity. An alternative to obtaining yᵢ by clustering with an appropriate distance-based metric is to use an anomaly score. Here, a higher anomaly score should correspond to lower density, but it may not correspond directly or proportionately to distance-based sparsity. One such anomaly scoring method is isolation forests (IF), which build a forest (ensemble) of trees on subsets of the features. The trees perform binary splits on the ranges of the features to isolate observations. The more splits required to isolate an observation xᵢ, the more anomalous it is. The anomaly score (normalized to [0, 1]) may be used as yᵢ, so a higher score indicates lower density. IF is very fast and computationally light. It is important to note that since the feature space S=∩^{p}ⱼ₌₁ dom(Fⱼ) (where dom (Fⱼ) denotes the domain of Fⱼ) is the bounding hyper-rectangular shape of all observations in D, its definition is sensitive to outliers if they affect the boundary points of the domain of a feature. For example, when F₁ is INCOME, and the current domain is [$0, $200,000]. If a new observation is added with F₁=$1,000,000, the dom(F₁) now grows five-fold. Assuming none of the other feature domains are affected, S now grows five-fold along the F₁ dimension. Since V (S) must always be 1, this means this single observation has created an empty region S={$200,000<INCOME<$1,000,000} of volume approximately 0.8, and so the non-empty regions built on D previously would now shrink by approximately a factor of 5. Such outliers will tend to receive a score yᵢ that indicates high sparsity or anomalousness.

According to some embodiments of the present disclosure, to make the partition more robust, it may be wise to omit a given percentage p of the highest values of a target yᵢ to consider as indicating an outlier, and the observations xi with the highest p percent of targets yᵢ before defining S and conducting the partition, According to some other embodiments a given percentage p of lowest values of a target yᵢ to consider as indicating an outlier, and the observations xᵢ with the lowest p percent of targets yᵢ may be omitted before defining S and conducting the partition. For example, the highest 1% of sparsity scores before defining S and conducting the partition. If this million-dollar income observation is unique in the dataset, including it in the partition may make the results non-robust, and so it may be dropped. However, when for example, 5% of the observations have income of $1,000,000, and the next highest income is $200,000, these high earners will likely be neighbors of each other in S, giving them less extreme density targets than otherwise. Even though they are unusual relative to the other observations, some of them will likely be included in D even if, for example, the sparsest 1% are trimmed. Trimming the sparsest observations can affect observations not on the boundaries of S if, for example, they are surrounded by relatively empty space. In this case, trimming them may give a more parsimonious representation of the empty space than if the partition has to ‘cut around’ these observations. This is a similar issue to the general decision of how many outliers to trim from a sample when estimating the population distribution to make the estimate robust to outliers. When points that are unusual but not very extreme are trimmed, the resulting estimate may not be accurate since these unusual points in fact do describe the distribution.

According to some embodiments of the present disclosure, once there is a numeric target y which serves as a measurement associated to some attributes of the density, a density-based partition of S may be obtained by a model mapping D→y. If the model performs hierarchical binary splits on the input features F1, . . . , Fp, this yields interpretable rectangular shapes on these features. One such techniques are regression trees. Regression trees construct binary trees on the input features, which at each node conduct a binary split on one of the features (or a one-hot encoding column corresponding to one level of a nominal categorical feature) such that the mean squared error (or a similar metric) of the numeric target {yᵢ} for observations xᵢ is minimized given the choice of split on the range of the chosen feature Fj.

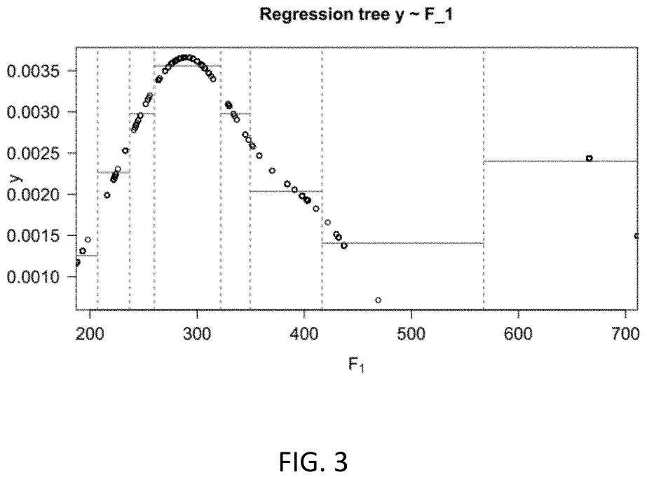

FIG. 3 schematically shows an example, where a regression tree maps a univariate feature x=F₁ to a numeric target y, where yᵢ=f(xᵢ) is the kernel density estimation (KDE) of F₁ at a given value xᵢ, according to some embodiments of the present disclosure. Each vertical dashed line is a split on F₁ in the tree, and the interval between each pair of consecutive dashed vertical lines constitutes a region, or region. For instance, here dom(F₁)=[187, 711] and there are 8 regions, where S1={187≤F₁≤207} and S₈={567.5<F1≤711}. Within each region, the solid horizontal line is E(yᵢ|xᵢ∈Sⱼ), the average value of yᵢ in each region. Since y is the KDE, this average reflects the average density of the observations, and thus follows the shape of the KDE curve. In this way, the set of regions {Sj}⁸ⱼ₌₁ represents a density-based partition of the observed span dom(F₁).

According to some embodiments of the preset disclosure, code 102 executed by processor 101 is able to carve out regions that represent empty space in S. An empty space is searched for in two locations:

1. only on the feature and split value used by the regression tree at that step;

2. after splitting, at any feature and location of the ‘outside’ of the observed points in that region.

According to some other embodiments of the present disclosure, another heuristic would be to find internal empty space in a given region, which would split the region into at least one empty region and, at least two new non-empty regions.

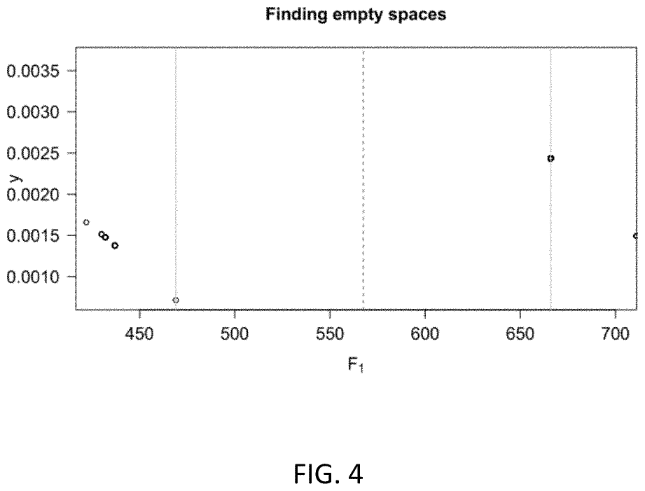

FIG. 4 schematically shows an illustrative example of empty spaces around split between S₇ and S₈ in FIG. 3, according to some embodiments of the present disclosure. In FIG. 3, the rightmost two regions are S₇={416.5<F₁≤567.5} and S₈={567.5<F₁≤711}. However, the interval (469, 666), FIG. 4, is empty, which is useful information to the user. The split points (e.g., F₁=567.5) are the mid-points between the highest and lowest values in the regions on the left and right, respectively, and the splitting decision is typically greedy in that it does not account for empty space in the observed values of numeric features Fⱼ. The length of this empty interval is 0.3755782 of the overall domain. The code 102 executed by processor 101, uses a heuristic that empty space, such as (469, 666) above, which straddles the location of a regression tree split, will only be carved out if its length L(⋅)>minL, for a user-specified value 0≤minL≤1. Setting minL=1—that is, the maximum possible—means no empty space will ever be carved out, and so the partition remains as in FIG. 1, where each region contains observations. Setting minL=0 means all possible empty space (subject to the limit p* on region dimension), no matter how small, will be carved out, which over-fits the partition to the observed data, in which case the empty regions may not represent real feature constraints, but rather artefacts of the data. It is recommended to set minL=0.1, for instance. In that case, the empty space in FIG. 4 would be large enough, and so the resulting partition would have S₁, . . . , S₆ as in FIG. 3, but with S₇={416.5<F₁≤469}, an empty region S8={469<F₁<666} and S₉={666≤F₁≤711}. The example shown here is on numeric data, but the same procedure applies to nominal categorical features, as discussed below.

According to some embodiments of the present disclosure, after carving out empty space from splits, a heuristic is also employed to carve out empty space anywhere on the ‘outside’ of a given region Sₖ after it is formed from a regression tree split, as opposed to specifically at the regression tree split feature and value. Code 102 executed by processor 101, determines the empty space between the boundaries of Sk and the boundaries of the observed {xᵢ: xᵢ∈Sₖ}. For instance, in the above, S₂={207<F₁≤237}, but the observed values span only [216, 233]. The empty boundary space for this feature in region S₂ is s′_{2,1}=(207, 216) U (233, 237]. For real-valued, integer-valued, or ordered categorical features, this empty space may be a union of two sets. If p≥2, this trimming can occur on any of the features, while the first form of trimming occurs only on the feature used to split the nodes, and only at that split threshold. The (potentially zero-size) boundary gaps s′_{k,j} in region Sk are calculated for each feature Fj, j=1, . . . , p. If any have L(s′_{k,j})>minL, these are iteratively trimmed in decreasing order of size, resulting in an empty space of Sk∩s′_{k,j}, and Sₖ is redefined as Sₖ\(Sₖ∩s′_{k,j}), subtracting the empty space. That is, the interval s_{k,j}, which defines Sk on feature Fj is redefined as s_{k,j}\s′_{k,j}. For instance, S2 could then be re-defined as the smaller S2={216≤F1≤233}, and two new empty regions, {207<F1<216} and {233<F1≤237} would be added, since the empty gap S2∩s′_{2,1} consists of non-contiguous intervals. In each iteration, before trimming, the region Sk=∩^{p}ⱼ₌₁ sk,j. Carving on Fj results in a trimmed region Sk=(∩i≠j s_{k,i})∩(s_{k,j}\s′_{k,j}) and one or two (if s′_{k,j} is non-contiguous) empty region(s) (∩i≠j s_{k,i})∩(s′_{k,j}), which have the same definition on all features except j. If, before trimming s_{k,j}≠dom(Fj), then Sk was already defined on Fj. Hence, region Sₖ's dimension does not increase after trimming, and also equals the dimension of the empty region. Otherwise, if s_{k,j}=dom(Fj) before trimming, its dimension would increase by 1, and so would the empty space. Thus, for trimming to occur at each iteration, two conditions must be met:

1. The dimension of Sₖ must remain ≤p* after trimming. That is, it must have either been <p*, or, if the dimension was =p*, it must have been defined on Fⱼ.

2. The resulting empty region must be large enough on all dimensions. That is, there must be L(s_{k,i})>minL, ∀i≠j, and L(s′_{k,j})>minL as well. This restriction applies only to the empty space, and recall that no such restriction is put on the regression tree when forming the regions initially. If, for instance, the resulting Skis re-defined such that L(s_{k,j}\s′_{k,j})≤minL (it is ‘narrow’ along feature Fj), this is fine.

In the example of S₂ above defined only on F₁, L(s′_{2,1}) is too small to trim, so S₂ is left as is. Note that for simplicity, the illustrations of regression trees and empty space carving have used a univariate numeric case, but the same calculations of empty space carving can be done on categorical features as well. For instance, when there are two features F₁ and F₂, where F₂ is LOCATION, with dom(F₂)={North, East, South}. S is first partitioned only on F₁ into regions S₁ and S₂. That is, S₁=s_{1,1} and S₂=s_{2,1}, which are complementary subsets of dom(F₁). Even though S₁ is not defined on F₂ (i.e., currently s_{1,2}=dom(F₂)), assume S₁ only contains observations with F₂∈{East, North} (all South individuals are in S2). There is therefore an empty gap in this region, s′_{1,2}={F2∈{South}}, where the complement is s_{1,2}\s′_{1,2}={North, East}. That is, S₁ could be defined on F₂ as well, since the data it contains do not span the full dom(F₂). This gap has length L(s′_{1,2})=1/3, since it contains one of three possible values of LOCATION, and forms an 2-dimensional empty region defined as S₃=S₁∩s′_{1,2}. If the maximum dimension p*>1, and if S₃ is large enough on all sides (both L(s_{1,2}), L(s′_{1,1})>minL), then S₃ (South individuals satisfying S₁, which are unobserved in D) becomes a new empty region, defined as S₃=s_{3,1}∩s_{3,2}, where s_{3,1}=s_{1,1} and s_{3,2}=s′_{1,2}. S₁ is re-defined as S₁\(S₁∩s′_{1,2})=s_{1,1}∩(s_{1,2}\s′_{1,2}) (narrowing S₁ to omit South individuals, a combination that is not observed in D).

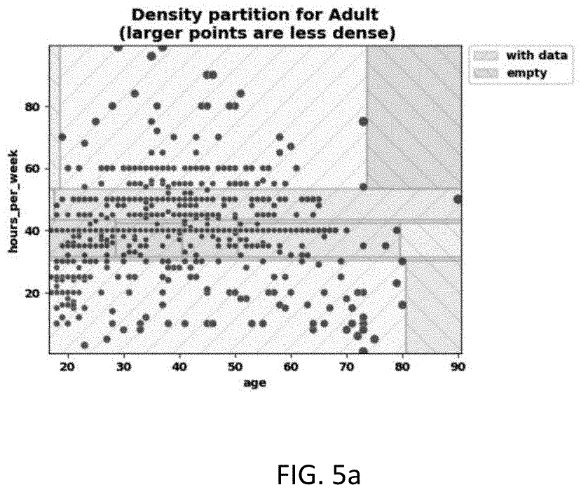

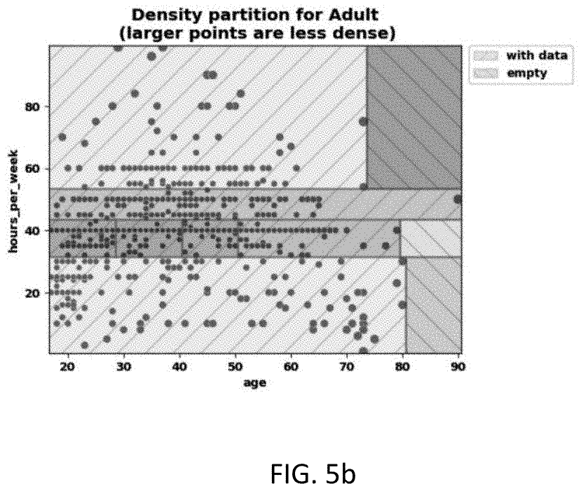

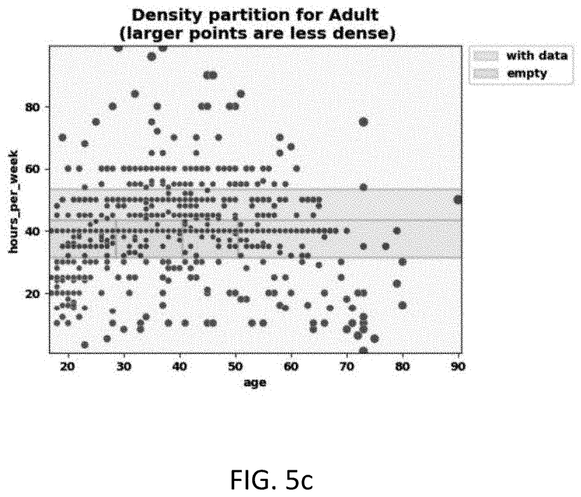

Reference is now made to FIGS. 5a-5c, which schematically show an example of density-based partition of n=1000 observations from ‘Adult’ dataset on F₁=AGE and F₂=HOURS PER WEEK, where in FIG. 5a minL=0.0, in FIG. 5b minL=0.1, and in FIG. 5c minL=1.0, according to some embodiments of the present disclosure. An Adult dataset, which is, a subset of records of respondents to the United States (U.S.) Census conducted in 1994, was used in the examples of FIGS. 5a-5c. The illustrations use a n=1,000-observation subset and only the F₁=AGE and F₂=HOURS PER WEEK (hours worked per week) features. Note, the dataset was filtered to omit non-working respondents, that is, with HOURS PER WEEK=0. Thus, p=2 and p*=2 as well, to allow partitions to be made on both features. Both features are also coded as integer-valued. An additional parameter, min_region_size_frac, not discussed earlier, is set to 0.1, meaning the regression tree does not form a leaf (i.e., a potential partition region) if contains less than 10% of the dataset observations (0.1n), with a minimum size of 2 observations. This is a form of robustness control on the partition.

A visualization of a scatterplot of the dataset observations, with an overlay of rectangles representing the resulting partition is presented in FIGS. 5a-5c. Seven non-empty regions are found for each, but the partitions differ in the amount of empty space carved out from these regions to form new empty regions, so the total number of regions may differ. The plots are shown for values of minL=0.0, 0.1, and 1.0, which controls the amount of empty space carved out. As noted, FIG. 5a, with minL=0.0, results in many small empty partitions, since all empty spaces of any size are carved out. The resulting partition is unlikely to be very robust to, for example, another sample similar to D, due to the overfitting. In FIG. 5c, on the other extreme, no empty spaces are carved out. One-dimensional regions are rectangles for which one side occupies the entire axis (such as the rightmost region in this plot), and two-dimensional regions have both sides being shorter than the respective axes. In FIG. 5b, with minL=0.1, only three empty regions, in the upper and lower right-hand corners, are found. These represent a constraint that, in the given dataset, at least, that workers are unlikely to be older (recall non-workers are omitted). Furthermore, the upper right hand empty space is wider along the AGE axis, indicating that older workers (which are for example, at their mid-70s) are unlikely to work a high number of hours (above 55, for example) per week. Note that there is a single unusual respondent aged 90, who is significantly older than the next oldest respondent, aged 80, and retaining such outliers can alter the configuration of regions. In addition to this outlier, there are several outliers in the upper portion of the plot of FIG. 5b, indicating respondents working a very high number of hours (more than 90). The more dense (smaller points), more ‘typical’ observations are in the center of S, containing respondents of typical working ages (20s-60s) working typical workweeks (≈30-60 hours per week). Here, the regions tend to have smaller volume to fit the bulk of the data better.

According to some embodiments of the present disclosure, once a density partition S₁, . . . , Sₖ is made of S, some calculations may be performed to summarize the results. A realistic dataset should have unevenly-distributed points within S, and these partitions by density, in addition to empty spaces, if found, should characterize the domain constraints of the features. Hence, a realistic dataset- or a synthetic dataset generated to have realistic, and not independent, inter-feature associations-should have regions of various volumes and densities. In addition to summarizing the distribution of observation density in a single dataset, the distributions of two different datasets may also be compared in the following non-parametric way. Say a partition on D results in K regions.

$$Let φ ( {S}_{k} ) = \frac{{Σ}_{i = 1}^{n} I ( xi ∈ S k )}{n} ,$$

k=1, . . . , K be the fraction of the observations in D contained in region Sₖ. φₖ=0 if Sₖ is empty space. If the distribution of observations in D is perfectly uniform within the feature space S, each region Sₖ should have V (Sₖ)=φ(Sₖ). Regions Sₖ that are denser than average should have φ(Sₖ)>V (Sₖ); that is, the region covered by Sₖ contains a higher fraction of observations than its volume (which is a fraction of the total feature space volume). Recall that both Σₖ φ(Sₖ)=Σₖ V(Sₖ)=1. This indicates that a chi-squared statistic

$$χ ( D , \{ {S}_{k} \} ) = \frac{{Σ}_{k = 1}^{K} ( φ ( Sk ) - V ( Sk ) ) 2}{V ( S k )}$$

where the statistic χ(D, {Sk}) follows a chi-squared distribution with K−1 degrees of freedom (χₖ₋₁². A perfectly uniform dataset D should have χ(D, {Sk})≈0; in the most extreme case, the algorithm will not be able to generate a partition (detecting no variances in density), and thus K=1 with S1=S, and V(S₁)=φ(S₁)=1. The volumes are set as the expected values of φ(Sₖ) under the null hypothesis of uniformity since V(Sₖ)>0, ∀k, while φ(Sₖ) may equal 0. The p-value of this statistic, according to the chi-squared distribution, can measure the likelihood the distribution is non-uniform, and the value

$$\frac{χ ( D , \{ S k \} )}{K - 1}$$

can be used as a simple metric to compare uniformity of density between different datasets D and D′ by their respective density partitions, where higher values indicate less uniformity. According to some embodiments of the present disclosure, an implementation of the present disclosure may be for identifying empty spaces in a trained machine learning model dataset which indicates to the user the empty spaces, or the sparse regions are probably inaccurate and should not be used. Since a received dataset is partitioned into dense, sparse, and empty regions, empty or very sparse data regions are areas where there may not be enough data to either train a machine learning model (e.g. perhaps observations there should be excluded from training) or perhaps the predictions of the machine learning model on observations there are not to be trusted. When observations from a test dataset fall into previously empty regions, or are out of bounds of the previous feature space (e.g. they have a higher or lower value on at least one feature than what was observed previously), these may be especially of concern. For example, for a dataset of two features, “height” and “weight” of humans. Assume the domains of height are from 0.5-2.5 m and the domains for weight are from 50 kg-200 kg. However, assume there are no people in the region {150-200 kg} and {2-2.5 m}, that is, this is an empty region. Assume that a machine learning algorithm was trained to predict some other feature based on height and weight, for instance a nearest neighbors classifier. Assume that, in the test set there are two observations: one person who weighs 175 kg and is 2.25 m high. Another person weighs 300 kg. The first is in a previously empty region, the second is out of the previous domain. The machine learning classifier gives a prediction result for them, but it is likely that it is not to be trusted. However, the classifier itself will not typically provide an indicator that the prediction may not be with confidence. However, executing the code 102 by processor 101, easily indicates these two and explain that it is in a previously empty region defined on the height and weight features (which may be only a subset of the dataset features). That is, it is able to be explained.

Another example for using the method disclosed herein may be in cases of causal inference. Essentially it may be able to see if certain empty or sparse regions (hyper-rectangular shapes) are also data subsets that suffer from lack of any diversity of observed values of a target class variable that is being tried to be modeled in causal inference (herein after, lack of “positivity”). For instance, in causal inference it may be wanted to predict what the effect of taking a given medication is on a blood pressure of a person, as compared to not taking the medication. If it is desired to predict what the outcome is for, Parkinson patients, it is needed to observe some smokers who did and some who did not take the medication. If there is only data on smokers who took the medication, this is lack of “positivity”, since there is no data at all about what would happen if these smokers did not take the medication. According to some embodiments of the present disclosure, this subset is the hyper-rectangular shape {PARKINSON PATIENTS={yes}} and {MEDICATION={no}}, which is empty, and hence is {PARKINSON PATIENTS={yes]} is a relevant subset on which it cannot be made either any predictions, or perhaps cannot trust the predictions made for these hyper-rectangular shapes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for automatically identifying in a dataset insufficient data for learning, or records with anomalous combinations of feature values, by partition of numeric and/or categorical data space into human-interpretable regions will be developed and the scope of the term methods and systems for automatically identifying in a dataset insufficient data for learning, or records with anomalous combinations of feature values, by partition of numeric and/or categorical data space into human-interpretable regions, is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computerized method for automatically identifying in a dataset insufficient data for learning, or records with anomalous combinations of feature values, by partition of numeric and/or categorical data space into human-interpretable regions, comprising:
receiving a dataset of numeric and/or categorical features with a plurality of observations;
calculating observation density for each observation according to a distance or anomaly based metric, and receiving a density measurement representing a density of each observation;
partitioning the dataset along the numeric and/or categorical features according to the density measurement of each observation by a perpendicular cut along the feature spaces, receiving a map of a plurality of hyper-rectangular shapes representing various levels of density including empty spaces;
displaying the received map of plurality of hyper-rectangular shapes, being human-interpretable regions on a Graphic user interface, GUI, wherein the plurality of hyper-rectangular shapes are selectable and present information about the selected hyper-rectangular shape level of density when selected by a user.

2. The method of claim 1, wherein a machine learning is applied to the dataset which comprises:
insufficient data for a trained machine learning model to provide high accuracy results; or
records with anomalous combinations of feature values, which indicates on errors in the machine learning model results or errors in input data.

3. The method of claim 1, further comprising:
calculating additional metrics of volume spanned by the hyper-rectangular shapes;
deviation of fraction of observations contained in a hyper-rectangular shape from the fractional volume contained in the hyper-rectangular shape, to measure how uneven the observations are spread in a multi-dimensional space.

4. The method of claim 1, wherein partitioning is done so that the partitions differ as much as possible among themselves in density.

5. The method of claim 1, wherein calculating observation density for each observation is done by clustering the dataset of numeric and/or categorical features using Ordering Points To Identify the Clustering Structure, OPTICS, with Gower's metric.

6. The method of claim 1, wherein calculating observation density for each observation is done by calculating an anomaly score to each observation, where a higher anomaly score corresponds to lower density.

7. The method of claim 1, wherein the anomaly based metric is Isolation Forests, IF.

8. The method of claim 1, wherein partitioning the dataset along the numeric and/or categorical features is done by a regression decision tree.

9. The method of claim 1, wherein partitioning the dataset along the numeric and/or categorical features, is recursive.

10. The method of claim 1, wherein the perpendicular cut is successive.

11. The method of claim 1, wherein a given percentage p of highest values of a target yi to consider as indicating an outlier, and the observations xi with the highest p percent of targets yi are omitted before defining S and conducting the partition.

12. The method of claim 1, wherein a given percentage p of lowest values of a target yᵢ to consider as indicating an outlier, and the observations xi with the lowest p percent of targets yᵢ are omitted before defining S and conducting the partition.

13. The method of claim 8, wherein an empty space is searched for in two locations:
only on a feature and split value used by the regression tree at a same step; and
after splitting, at any feature and location of outside of observed points in a same region.

14. The method of claim 8, wherein an internal empty space is found in a given region, which splits the region into at least one empty region and, at least two new non-empty regions.

15. A system for automatically identifying in a dataset insufficient data for learning, or records with anomalous combinations of feature values, by partition of numeric and/or categorical data space into human-interpretable regions, comprising:
a processor executing a code, adapted to:
receive a dataset of numeric and/or categorical features with a plurality of observations;
calculate observation density for each observation according to a distance or anomaly based metric, and receiving a density measurement representing a density of each observation;
partition the dataset along the numeric and/or categorical features according to the density measurement of each observation by a perpendicularly cut along the feature spaces, receiving a map with a plurality of hyper-rectangular shapes representing various levels of density including empty spaces; and
a graphic user interface, GUI, controlled by the processor, which displays the map with the plurality of hyper-rectangular shapes, being human-interpretable regions, wherein the plurality of hyper-rectangular shapes are selectable and present information about the selected hyper-rectangular level of density when selected by a user.

16. The system of claim 15, wherein a machine learning is applied to the dataset which comprises:
insufficient data for a trained machine learning model to provide high accuracy results; or
records with anomalous combinations of feature values, which indicates on errors in the machine learning model results or errors in input data.

17. The processor of claim 15, further adapted to:
calculate additional metrics of volume spanned by the hyper-rectangular shapes;
deviation of fraction of observations contained in a hyper-rectangular shape from the fractional volume contained in the hyper-rectangular shape, to measure how uneven the observations are spread in a multi-dimensional space.

18. A computer program product for automatically identifying in a dataset insufficient data for learning, or records with anomalous combinations of feature values, by partition of numeric and/or categorical data space into human-interpretable regions, the computer program product comprising:
one or more computer readable storage media, and program instructions collectively stored on the one or more computer readable storage media, the program instructions comprising:
program instructions to receive a dataset of numeric and/or categorical features with a plurality of observations;
program instructions to calculate observation density for each observation according to a distance or anomaly based metric, and receiving a density measurement representing a density of each observation;
program instructions to partition the dataset along the numeric and/or categorical features according to the density measurement of each observation by a perpendicular cut along the feature spaces, receiving a map of a plurality of hyper-rectangular shapes representing various levels of density including empty spaces; and
program instructions to display the received map of plurality of hyper-rectangular shapes, being human-interpretable regions on a Graphic user interface, GUI, wherein the plurality of hyper-rectangular shapes are selectable and present information about the selected hyper-rectangular shape level of density when selected by a user.

19. The computer program product of claim 18, wherein a machine learning is applied to the dataset which comprises:
insufficient data for a trained machine learning model to provide high accuracy results; or
records with anomalous combinations of feature values, which indicates on errors in the machine learning model results or errors in input data.

20. The computer program product of claim 18, further comprising:
program instructions to calculate additional metrics of volume spanned by the hyper-rectangular shapes; deviation of fraction of observations contained in a hyper-rectangular shape from the fractional volume contained in the hyper-rectangular shape, to measure how uneven the observations are spread in a multi-dimensional space.
